(19) United States
(12) Patent Application Publication
(10) Pub. No.: US 2026/0014568 A1
(43) Pub. Date: Jan. 15, 2026

(54) METHOD FOR COLLECTING INERT PARTICLES IN KITCHEN WASTE SLURRY BASED ON VENTURI-TYPE PARTICLE COLLECTOR

(71) Applicant: TONGJI UNIVERSITY, Shanghai (CN)

(72) Inventors: Tao ZHOU, Shanghai (CN); Zongsheng LI, Shanghai (CN); Youcai ZHAO, Shanghai (CN); Linhai YE, Shanghai (CN); Lu PENG, Shanghai (CN)

(73) Assignee: TONGJI UNIVERSITY, Shanghai (CN)

(21) Appl. No.: 18/707,596

(22) PCT Filed: Jan. 22, 2024
(86) PCT No.: PCT/CN2024/073419

§ 371 Date: Oct. 1, 2025

(30) Foreign Application Priority Data
Feb. 27, 2023 (CN) 202310168539.7

(51) Int. Cl. B03B 5/64; B01D 21/00

(52) U.S. Cl. CPC B03B 5/64; B01D 21/0003; B01D 21/0012

(57) ABSTRACT

The present invention relates to an apparatus for collecting inert particles in a kitchen waste slurry, and in particular to an apparatus and method for collecting inert particles in a slurry by applying Venturi effect. The method includes the steps: an apparatus for collecting the inert particles based on the Venturi effect, a method for drawing a pipeline flow velocity cloud plot, a method for counting a concentration of the inert particles, etc. By means of a method for counting a flow velocity, a concentration of inert substances in the slurry and a particle density in a target kitchen waste slurry, an optimal arrangement solution of an inert particle collector is determined. A Venturi-type inert particle collecting apparatus of the present invention includes an inert particle settling apparatus, a particle storage apparatus, and a connection portion between the apparatuses. With stable recovery of the inert particles in the kitchen waste slurry as a target, through simulation and field debugging of flow conditions and a content of inert substances of the slurry, and feedback adjustment on each recovery of the inert substances, the present invention obtains a stable recovery cycle, and finally achieves sustainable and stable recovery of inert particles in the kitchen waste slurry.

### TECHNICAL FIELD

The present invention belongs to the field of kitchen waste pretreatment devices, relates to a method for collecting inert particles in a kitchen waste slurry, and in particular to a collector for inert particles in a kitchen waste slurry based on Venturi effect control, belonging to the fields of solid sedimentation, fluid mechanics, environmental engineering and the like.

### BACKGROUND

Inert particles in kitchen wastes refer to various inorganic or organic particles and fragments that cannot be used by subsequent anaerobic fermentation microorganisms in a slurry obtained by kitchen waste slurrying. During pretreatment on kitchen wastes, impurities with large particle sizes (larger than 20 mm) are removed by screening, and then the kitchen wastes are crushed and slurried; residual fine inert particles are left in a pipeline, to be pumped into an anaerobic fermentation tank with the waste slurry together; and scums float at an upper part of the slurry or settle at a bottom of the anaerobic tank, thereby causing blockage. The presence of the inert particles greatly hinders pretreatment on the kitchen wastes and sustainability of anaerobic fermentation. At present, separation of the inert particles is mainly performed by using cyclone desanding, centrifugal impurity removal and other modes, which is costly and needs a large occupied area. It is not suitable for improvement on an existing process, and there is no removal technology specifically for the fine inert particles in the slurry at the same time.

A huge amount of kitchen wastes can be produced in China every year, and inert substances account for a certain proportion of the kitchen wastes. At present, a method for collecting the inert substances in a pretreatment link of the kitchen wastes is relatively single, and commonly uses procedures of crushing, screening and separation. Before kitchen waste slurrying, original wastes are screened by a large substance sorting machine to remove impurities with particle sizes larger than 60 mm, and then screened by a fine sorting machine to remove impurities with particle sizes larger than 20 mm. The impurities mainly include small-particle-size sundries such as bottle caps and chopsticks, and light sundries such as plastics and paper. Materials with particle sizes smaller than 20 mm are prepared into a slurry with a diameter smaller than 8 mm, and then pumped into a sand and impurity removal unit; heavy substances (such as shells, glasses, porcelain slices, sands and other fine fibers) in the materials are removed by the sand and impurity removal unit; and then the materials enter an oil extraction unit.

At present, sorting of the materials in the kitchen waste pretreatment process is a main technical problem. At present, there are mainly two technologies for sorting the kitchen wastes. One technology is to set only one comprehensive sorting device; and the other technology is to set a multi-level sorting device, which basically adopts procedures of crushing, screening, and sand and impurity removal. Due to complexity of kitchen waste raw materials, in a case of one comprehensive sorting device, a flow rate of the kitchen wastes must be large, and a treatment velocity is fast. In order to ensure that a screening particle size of a discharge material is not small, there are many impurities and large particles in the slurry after slurrying; and meanwhile, device replacement will be very frequent, which will affect normal production. A plurality of grading devices will lead to the problems such as a too long pretreatment flow and an increased loss of organic matters.

The existing process cannot screen out slags from all the inert substances in a pretreatment stage; while the multi-stage sorting will make the inert particles finer and more difficult to settle. Therefore, the benefit and the cost of adding a screening or sedimentation device in the existing process are not proportional. Broken fine inert particles will wear subsequent pretreatment facilities such as a three-phase centrifuge and a transportation pipeline to different degrees. Whether the inert substances can promote anaerobic fermentation of the kitchen wastes is still unknown currently, but too many inert substances will reduce an effective volume of the anaerobic tank, unsmooth material inlet and outlet and the like. Moreover, replacement and maintenance of large devices are very costly.

### SUMMARY OF THE INVENTION

The technical problem to be solved by the present invention is to deal with kitchen wastes, especially to rapidly and efficiently collect inert particles in a kitchen waste slurry, so as to achieve periodic and sustainable collection of the inert particles in the kitchen waste slurry.

In order to solve the above problem, the present invention designs a method for collecting inert particles in a kitchen waste slurry by using a Venturi-type collector for inert particle in kitchen wastes, and a collector for inert particles in a kitchen waste slurry based on a Venturi effect is designed for matching, to achieve a sustainable collection solution of the inert particles in the kitchen waste slurry.

In order to achieve the above purpose, the method for collecting the inert particles in the kitchen waste slurry of the present invention includes the following two stages:

First, investigating a flow velocity and a viscosity of the slurry according to a process condition in a target pretreatment project field; performing measurement by using a flow meter in an initial flow velocity measurement method, and performing a test at an access port and an observation port of a slurry pipe segment; drawing a flow velocity profile at a pretreated slurry pipe segment; measuring the viscosity by using a rheometer, measuring an initial concentration of the inert particles by means of drying and a gravimetric method after collection of samples, and drawing a slurry flowing cloud plot and a particle distribution cloud plot according to measured data; selecting an appropriate mounting pipe segment according to the slurry flowing cloud plot and a velocity cloud plot; after determination on the pipe segment, measuring a length of a straight pipe of the collector, a position of an inert substance discharge port, and a diameter ratio of front and rear pipes; performing parametric scanning determination by means of an apparatus design experiment and an ANSYS FLUENT fluid simulation test according to measurement on the initial flow velocity of the slurry in the field process and measurement on the initial concentration and density of the inert substances; and performing adjustment according to an actual content of inert substances in the slurry.

Second, achieving a collecting mechanism for the inert particles in the kitchen waste slurry.

The flow velocity (current velocity) refers to a displacement of liquid in unit time. Flow velocity distribution refers to distribution of flow velocity directions and sizes at various points on a certain section.

At present, there are few measurements on types of the inert substances in the kitchen wastes and a concentration of the inert substances in the slurry. This method quantifies hydromechanical data such as a content and the types of the inert substances in the slurry by means of a random sampling experiment. A two-phase flow model for the kitchen waste slurry flow is formed according to previous laboratory simulation and experimental results.

Simulation process: an initial geometric model of the collector is designed according to an inlet pipe diameter, a flow velocity, etc. (only one parameter needs to be randomly selected in a range). After mesh subdivision, the hydromechanical data of the slurry is input into a two-phase flow simulation model as basic parameters of simulation. According to flow simulation of the slurry for 30 min and 1 h, changes on a concentration of a dispersed phase and a position where the inert substances may be accumulated in the pipeline are observed.

According to selecting parameters such as an inlet diameter do, and a front and rear diameter ratio D/d within a range of 1.5-3, a throat diameter d and a settling straight pipe diameter D are selected; a throat angle (preferably, horizontal) and length (preferably, the length is equal to the pipe diameter) are selected by themselves; and a straight pipe length of the collector is decided based on a distance of a flow state, re-stabilized after the Venturi effect, of the slurry in simulation results. Parametric scanning optimization is performed on all combinations of the above parameters (that is, each parameter combination is simulated for observation on the changes on the concentration of the dispersed phase). Finally, the parameter combination with the lowest dispersed phase concentration and its position which is an inert substance discharge position are obtained.

Specifically, the present invention provides a method for collecting inert particles in a kitchen waste slurry, including the following steps:

(1) determining an optimal arrangement position and working conditions of the collecting apparatus, and estimating a removal amount of the inert particles and a number and a cycle of arranged collectors by testing an initial flow velocity, and testing and counting an initial concentration and a density of the inert particles in the kitchen waste slurry in a specific pipe segment, design parameters.

Preferably, first, needing to investigate the pretreated pipe segment, and select the pipe segment after slurrying (a connection pipe segment between a slurrying machine and a sand and impurity removal unit), a pipe segment after sand and impurity removal (a connection pipe segment between the sand and impurity removal unit and an oil removal unit), and a pipe segment after three-phase separation (a pipe segment before entering a homogenizing tank); and mounting the collector on a pipe segment with a stable flow velocity.

Selecting results of the minimum concentrations of the inert particles in simulated final states (for example, after a test for 20-60 min) according to results of parametric scanning, and estimating a removal amount of the inert particles by a difference between the two, wherein the number of the arranged collectors is determined by a required inert removal rate. If a simulated initial concentration is a %, a minimum concentration of the particles after simulation is b %, and a required concentration is c %, then a calculation formula of the number n of required arranged collectors is as follows:

$$= \frac{( - )}{-}$$

Only rounding is required.

An operation cycle is to perform collection twice a day, i.e. once every 4 hours, and the cycle can be adjusted according to quality of the slurry every day.

(2) Arranging the Venturi-type inert particle collector at the optimal arrangement position determined in step (1), hanging a filter mesh in the collection apparatus, and confirming an interface of the pipeline to be firm; and performing a preliminary settlement test, adjusting and optimizing the parameters, and putting the Venturi inert particle collector into formal use after the test.

First, judging whether it is necessary to adjust an opening position and a diameter of a particle collection pipe according to a preliminary settlement effect; and then, judging whether it is necessary to change an aperture of a screen mesh according to the field flushing and screening conditions of the inert substances, and then determining a final settlement cycle according to a settlement effect.

(3) Calculating a reasonable recovery cycle of the inert particles by the concentration and the density of the inert particles measured and estimated in step (1); after the end of settlement collection in each test, manually opening a collection pipeline port, discharging the settled inert particles by means of a collection pipeline, and adjusting the position and the settlement cycle of the collector according to the collection condition; and enabling the collected inert substances to enter a pretreatment and slag outlet system, and enabling the slurry passing through the filter mesh to return to a pretreatment system.

(4) Repeating step (3) until a stable inert material recovery cycle is obtained by adjustment, which forms a processized collection system for the inert particles in the kitchen waste slurry, and reduces a content of the fine inert particles in the slurry; and entering a sustainable removal mode stage.

Preferably, when a fluctuation height of the particles collected by an inert substance collection pipe is smaller than 5 cm every day, and the effect can be regarded as stable if the final effect of collecting the inert particles is stable for one continual week.

Preferably, the initial flow velocity measurement method includes the following steps:
performing measurement by using the flow meter, and measuring the viscosity by using the rheometer;
drawing the flow velocity profile at the pretreated slurry pipe segment;
measuring the initial concentration of the inert particles by means of drying and a gravimetric method after collection of the sample, and drawing the slurry flowing cloud plot and the particle distribution cloud plot according to the measured data; and
performing determination by means of an apparatus design experiment ANSYS FLUENT fluid simulation test according to measurement on the initial flow velocity of the slurry in the field process and measurement on the initial concentration and density of the inert substances; and performing adjustment according to the actual content of the inert substances in the slurry.

Preferably, a design on the Venturi structure of the target pipe segment is based on the existing measured flow velocity of the slurry and the initial concentration and density data of the inert particles in the slurry. Simulated parametric scanning is performed on the parameters of a Venturi pipe to obtain an optimal combination of parameters such as a settlement time, a diameter ratio, the initial flow velocity, and a diameter of a Venturi throat. According to simulation results, specific device parameters and a setting position of the apparatus are selected. The throat is a straight pipe with the smallest diameter in the Venturi pipe.

Preferably, the Venturi-type collector for the inert particles in the kitchen waste slurry includes an inlet pipeline interface, a variable-diameter Venturi pipe, the settling straight pipe, an observation flush pipe, the particle collection pipe, a filter mesh, a slurry flowing pipe, a reducing pipe, and an outlet pipeline interface.

Preferably, the inert particle collection apparatus uses the Venturi effect to separate the inert particles from a slurry main body. The inert particle collection apparatus takes the settling straight pipe as a main body. According to the simulation results, an opening is formed in a settlement and accumulation position of the inert particles in the straight pipe, and an observation flush port is formed in an upper part of a corresponding position of the opening to facilitate observation of the settlement condition and flushing during collection of the inert particles.

Preferably, the inert particle collection apparatus is arranged behind the variable-diameter Venturi pipe, wherein the settling straight pipe is connected to the Venturi pipe; the observation flush pipe is connected to an upper end of the settling straight pipe, and the particle collection pipe is connected to a lower end; and an outlet of the straight pipe is connected to the reducing pipe and the outlet pipeline interface. The three portions together form an inert particle collection apparatus.

Preferably, the collector for the inert particles in the kitchen waste slurry includes five portions: the settling straight pipe, the observation flush pipe, a connection pipe, the particle collection pipe, and the slurry flowing pipe. The observation flush pipe is used for observing deposition of the inert particles and flushing during collection to facilitate all the inert particles to enter the collection pipe. The particle collection pipe is provided with the filter mesh, and may be disassembled into two portions. A liquid phase portion returns to a slurry pool by means of the filter mesh, and the inert particles are collected and transported outward.

Preferably, a replacement operation of the filter mesh is done manually. By splitting the slurry flowing pipe of the collector of the inert particles in the kitchen waste slurry, the particle collection pipe segment is directly taken out, together with the inert substances therein. Besides, a new collection filter mesh is replaced and reconnected with a slurry flowing pipeline, and a new round of waste collection process starts.

Accordingly, the present invention further provides an apparatus for collecting inert particles in a kitchen waste slurry, including the Venturi-type collector for the inert particles in the kitchen waste slurry. The Venturi-type collector for the inert particles in the kitchen waste slurry includes the inlet pipeline interface, the variable-diameter Venturi pipe, the settling straight pipe, the observation flush pipe, the particle collection pipe, the slurry flowing pipe, the reducing pipe, and the outlet pipeline interface.

The inlet pipeline interface, the variable-diameter Venturi pipe, the settling straight pipe, the slurry flowing pipe, the reducing pipe, and the outlet pipeline interface are connected with each other sequentially. An inner diameter of the settling straight pipe is larger than the diameters of the inlet pipeline interface and the outlet pipeline interface. An inner diameter of the variable-diameter Venturi pipe is a portion with the smallest inner diameter in the Venturi-type collector for the inert particles in the kitchen waste slurry.

The observation flush pipe is arranged on one side of the settling straight pipe, and the particle collection pipe is arranged on the other side, corresponding to the observation flush pipe, of the settling straight pipe.

Preferably, the particle collection pipe includes the connection pipe and the filter mesh. The slurry passing through the filter mesh returns to the slurry pool, and the inert particles are collected and transported outward. A connection pipe cover is arranged between the connection pipe and the particle collection pipe. Preferably, the slurry may enter the slurry pool directly, and may further be sent into the slurry pool after being collected.

As shown in FIG. 1, the Venturi-type collector for the inert particles in the kitchen waste slurry consists of the following feature components: (1) the inlet pipeline interface; (2) the variable-diameter Venturi pipe; (3) a variable-diameter straight pipe; (4) the observation flush pipe; (5) the connection pipe; (6) the particle collection pipe cover; (7) a particle storage pipe; (8) the filter mesh; (9) the slurry flowing pipe; and (10) the outlet pipeline interface.

The Venturi effect is manifested in restricted flow which is a phenomenon that a flow velocity of a fluid is increased when the fluid passes through a reduced flowing section, wherein the flow velocity of the fluid is inversely proportional to the flowing section. According to the Bernoulli's theorem, it can be known that an increase on the flow velocity is accompanied by a decrease in a fluid pressure, which is the common Venturi phenomenon. Generally speaking, this effect means that a low pressure will be generated near a fluid flowing at a high velocity, which results in adsorption. A pipeline made by using this effect is called the Venturi pipe.

The present invention provides a Venturi-type apparatus for collecting the inert particles in the kitchen waste slurry, consisting of three portions: an inlet and outlet pipeline interface, the variable-diameter Venturi pipe, and the inert particle collector. The inert particle collector includes three portions: the observation flush pipe, the settling straight pipe, and the particle collection pipe. The observation flush pipe is used for observing deposition of the inert particles and flushing during collection to facilitate all the inert particles to enter the collection pipe. The particle collection pipe is provided with a filter hole, and may be disassembled into three portions: the connection pipe, the particle storage pipe, and the slurry flowing pipe. The slurry passing through the filter mesh returns to the slurry pool, and the inert particles are collected and transported outward.

Optimal values of a front and rear radius ratio of the variable-diameter Venturi pipe and a length of the throat are determined by fluid simulation. Relying on the Venturi effect, a slurry flow is rapidly accelerated in the throat. After the slurry enters a variable-diameter settling straight pipe, the inert particles are separated from the slurry main body and settle to a bottom of the pipe due to a gravity.

The observation flush pipe is connected to an upper side of the settling straight pipe. An observation port with a diameter of 50 mm larger than that of the collecting pipe is arranged just above the collecting pipe, to facilitate observation on a settling state of the particles during cleaning of the inert particles. Meanwhile, process water can be flushed from the upper side to help the inert particles all enter the collection pipe.

The particle collection pipe consists of four portions: the connection pipe, the particle storage pipe, the filter mesh, and the slurry flowing pipe. The particle storage pipe stores the deposited inert particles, and the filter mesh can block the particles to make the liquid-phase slurry to pass through. The settling straight pipe is a short connection pipe similar to a tee-junction at an inert substance outlet (as shown in FIG. 1), that is, the settling straight pipe and the connection pipe are integrated, and the particle collecting pipe is connected to the connection pipe, and is perpendicular to the settling straight pipe.

The apparatus for collecting the inert particles in the kitchen waste slurry of the present invention can be used for modular treatment of collection and sustainable recycling of the inert particles in the kitchen waste slurry.

Preferably, the observation flush pipe is connected to the upper side of the settling straight pipe. The observation port with the diameter of 50 mm larger than that of the collecting pipe is arranged just above the collecting pipe, to facilitate observation on the settling state of the particles during cleaning of the inert particles. Or the process water is flushed from the upper side to help the inert particles all enter the collection pipe.

Preferably, in the inert particle collection pipe, a pipe cover is arranged at the connection pipe portion. During normal operation of the process, the pipe cover is closed. After it enters the settlement cycle, the pipe cover is manually opened, to be connected with the particle collection pipe with the filter mesh; the flushed inert particles are intercepted by the filter mesh into the storage pipe; and the slurry and small particulate organic matters return to the pretreatment system after passing through the filter mesh.

The diameter of the aforementioned inlet pipeline interface is generally the same as that of a process transportation pipeline, so as to facilitate unified setting of the initial flow velocity.

The aforementioned outlet pipeline interface is a variable-diameter water outlet, which can increase the slurry velocity. After a diameter variation, the diameter is the same as an original process pipe diameter. Invariable front and rear pipe diameters can make a modification performed under an invariable overall process.

In the aforementioned inert particle collection pipe, the pipe cover is arranged at the connection pipe portion. During normal operation of the process, the pipe cover is closed. After it enters the settlement cycle, the pipe cover is manually opened, to be connected with the particle storage pipe with the filter mesh; the flushed inert particles are intercepted by the filter mesh into the storage pipe; and the slurry and small particulate organic matters return to the pretreatment system after passing through the filter mesh.

The present invention first uses the Venturi effect as a collection power for the inert particles in the kitchen waste slurry, and forms a complete set of modular method for collecting and sustainably recovering the inert particles in the kitchen waste slurry around the use of the collection apparatus based on this effect.

At present, there is no report on a method for removing the fine inert particles in the slurry. The method for collecting the inert particles in the kitchen waste slurry of the present invention has the following advantages:

By adding a certain number of the Venturi-type inert particle collectors of the present invention to the pipeline in the pretreatment process, the inert particles can be collected, and wear on the pipeline and a device in the pretreatment segment, and the content of the inert substances entering the anaerobic tank can be reduced. The apparatus does not add a large device in the existing process, and thus being small in occupied area and low in cost. It can be directly replaced by a straight pipe with the same length if it is not needed, so it has the modularization advantage, lowers the treatment cost, and achieves periodic and sustainable collection of the inert particles, which provides convenience for recycling of the kitchen wastes.

### BRIEF DESCRIPTION OF THE DRAWINGS

In order to be more clearly illustrating the technical solutions of embodiments of the present application, the drawings which are required to be used in the embodiments will be briefly described below. It is obvious that the drawings described below are a part of the embodiments of the present application. It will be apparent to one of ordinary skill in the art that other drawings may be obtained based on the accompanying drawings without inventive effort.

FIG. 1 is a schematic structural diagram of a Venturi-type apparatus for collecting inert particles in a kitchen waste slurry used in a method.

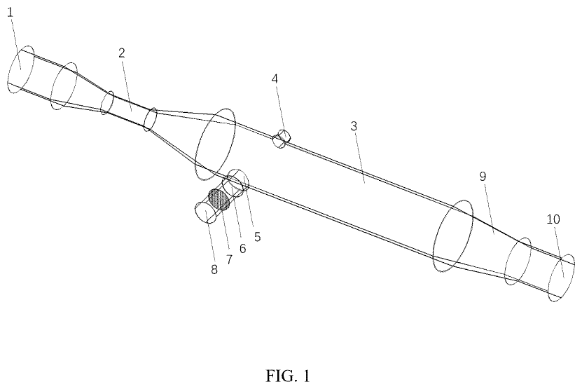

Reference numerals in the drawing: 1. inlet pipeline interface, 2. variable-diameter Venturi pipe, 3. settling straight pipe, 4. observation flush pipe, 5. connection pipe, 6. connection pipe cover, 7. particle storage pipe, 8. filter mesh, 9. slurry flowing pipe, and 10. outlet pipeline interface.

FIG. 2 is an implementation flowchart of the method.

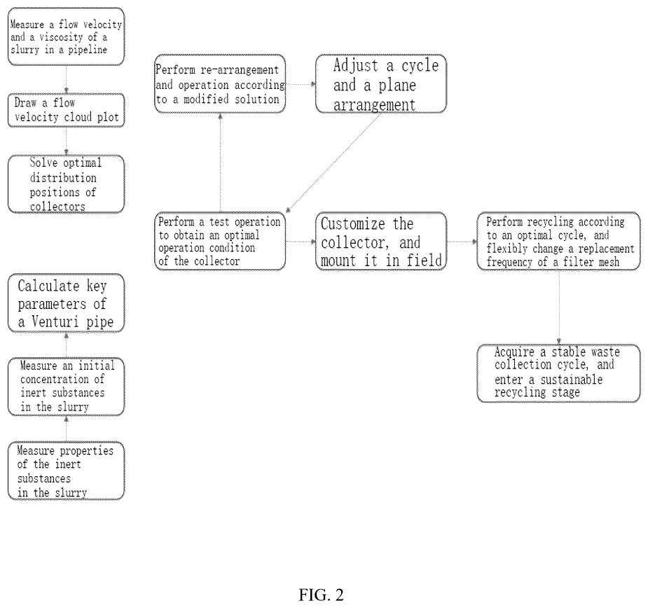

### DETAILED DESCRIPTION OF THE PREFERRED EMBODIMENTS

The technical solutions in embodiments of the present application are clearly and completely described below. Apparently, the embodiments described are merely a part of the embodiments rather than all embodiments of the present application. On the basis of the embodiments of the present application, all other embodiments obtained by those of ordinary skill in the art without making creative efforts shall fall within the scope of protection of the present application.

### Embodiment 1

In a kitchen waste pretreatment process segment, after slurrying, a slurry pipeline has a width of 1000 mm, and a flow velocity range is 1-2 m/s.

Velocities at various pipe segments after slurrying are measured by using the flow meter; and a flow velocity distribution cloud plot is drawn by collecting samples; and inert particle samples are collected for measurement on a density of inert particles, and estimation on an initial concentration of inert substances. The initial concentration of the inert substances is measured as 6%, and an average particle size is measured as about 4 mm. Through an ANSYS FLUENT simulation test and a field pre-experiment, a geometric model of the collector is designed according to an inlet pipe diameter, a flow velocity, etc. Hydromechanical data of the slurry is input into a two-phase flow simulation model as basic parameters of simulation. According to flow simulation of the slurry for 0.5 h, changes on a concentration of a dispersed phase is observed.

According to selecting parameters such as an inlet diameter do, and a front and rear diameter ratio D/d within a range of 1.5-3, a throat diameter d and a settling straight pipe diameter D are selected; a throat angle and length are selected by themselves complying with a design handbook (National standard GB/T-2624); and a straight pipe length of the collector is decided based on a distance of the slurry re-stabilized after the Venturi effect in simulation results. Parametric scanning optimization is performed on all combinations of the above parameters. Finally, the parameter combination with the lowest dispersed phase concentration and its position which is an inert substance discharge position are obtained.

There are main problems as follows:
1. In an early stage, hydrodynamic performance of the kitchen waste slurry is measured; the inert particles are screened; properties of the inert particles are determined; and a database required for slurry-inert substance simulation is established.

2. Kitchen wastes are a non-Newtonian fluid. During simulation, parameters of a two-phase flow model are adjusted to make a slurry flow closer to the real.

3. All combinations of a plurality of parameters are arranged and simulated one by one, to finally screen a parameter combination with the best effect.

After a plurality of tests and repeated optimization, optimally, the Venturi-type apparatus for collecting the inert particles in the kitchen waste slurry has a variable diameter ratio of a Venturi pipe of ⅓, a length of a throat of 500 mm, a length of a settling straight pipe of 7500 mm, a length of a diverging pipe of 1500 mm, a length of a reducing pipe of 1000 mm, and an aperture of the filter mesh of 3 mm.

### Embodiment 2

A collection apparatus is connected to the interior of a pipe segment, for collecting the inert particles every day. A collection cycle is replaced, the test is repeated for 14 days, and concentrations of the inert substances after settlement are all smaller than 4%. A maximum value of all the collection amounts is used as a volume of a required reservoir. An optimal diameter of the collection pipe is calculated to be 1000 mm which is the same as that of the settling straight pipe, and an optimal length of the collection pipe is calculated to be 800 mm. A diameter of an observation flush pipe is further set to be the same as that of the collection pipe. An optimal cycle is collection twice a day.

In combination with the above data, an arrangement of the Venturi-type apparatus for collecting the inert particles in the slurry is finally determined, and the apparatus is finally produced, and manually implemented and fixed.

A collection filter mesh is mounted on an inert particle storage cylinder. After an operation, collection is performed according to the calculated optimal cycle. After one month, a state of the filter mesh is manually checked, and replaced in time. A replacement frequency is adjusted according to a slurry incoming condition. If there is a larger amount of inert particles, the collection and screen mesh replacement cycles should be appropriately shortened. If there is a smaller amount of inert particles, the collection and screen mesh replacement cycles should be appropriately prolonged.

The above process of replacement of the filter mesh and adjustment is repeated until the cycle of each collection apparatus tends to be stable. The removed filter mesh can be used repeatedly after being cleaned until it is worn to complete damage, thereby forming a long-term stable inert particle collection mode, alleviating wear of a device pipeline in a pretreatment segment, and reducing a content of the inert particles in the slurry entering an anaerobic system.

The embodiments described above are merely specific implementations of the present application, but a protection scope of the present application is not limited thereto. Any change or substitution that may be conceived by any person skilled in the art without making creative efforts within the technical scope disclosed by the present application should be covered within the scope of protection of the present application. Hence, the scope of protection of the present application should be subject to the scope of protection of the claims in the present application.

1. A method for collecting inert particles in a kitchen waste slurry, characterized by comprising:
(1) by testing an initial flow velocity, and testing and counting an initial concentration and a density of the inert particles in the kitchen waste slurry in a specific pipe segment, determining design parameters, an optimal arrangement position and working conditions of the collecting apparatus, and estimating a removal amount of the inert particles and a number and a cycle of arranged collectors;
(2) arranging the Venturi-type inert particle collector at the optimal arrangement position determined in step (1), hanging a filter mesh in the collection apparatus, and confirming an interface of the pipeline to be firm; and performing a preliminary settlement test, and adjusting and optimizing the parameters;
(3) calculating a reasonable recovery cycle of the inert particles by the concentration and the density of the inert particles measured and estimated in step (1); after the end of settlement collection in each test, manually opening a collection pipeline port, discharging the settled inert particles by means of a collection pipeline, and adjusting the position and the settlement cycle of the collector according to the collection condition; and enabling the collected inert substances to enter a pretreatment and slag outlet system, and enabling the slurry passing through the filter mesh to return to a pretreatment system;
(4) repeating step (3) until a stable inert material recovery cycle is obtained by adjustment, which forms a processized collection system for the inert particles in the kitchen waste slurry, and reduces a content of the fine inert particles in the slurry; and entering a sustainable removal mode stage.

2. The method for collecting inert particles in the kitchen waste slurry according to claim 1, characterized in that the initial flow velocity measurement method comprises:
performing measurement by using a flow meter, and measuring the viscosity by using a rheometer;
drawing a flow velocity profile at the pretreated slurry pipe segment; and
measuring the initial concentration of the inert particles by means of drying and a gravimetric method after collection of the sample, and drawing a slurry flowing cloud plot and a particle distribution cloud plot according to the measured data.

3. The method for collecting inert particles in the kitchen waste slurry according to claim 1, characterized in that the length and a diameter ratio of front and rear pipes of a settling straight pipe of a Venturi-type inert particle collecting apparatus are measured according to the initial flow velocity of the slurry in a field process; the initial concentration and density of the inert particles are determined by means of an apparatus design experiment and ANSYS FLUENT fluid simulation test, and adjusted according to the actual content of the inert substances in the slurry.

4. The method for collecting inert particles in the kitchen waste slurry according to claim 1, characterized in that a design on the Venturi structure of a target pipe segment is based on the existing measured flow velocity of the slurry and the initial concentration and density data of the inert particles in the slurry; simulated parametric scanning is performed on the parameters of a Venturi pipe to obtain an optimal combination of parameters such as a settlement time, a diameter ratio, the initial flow velocity, and a diameter of a Venturi throat; and according to simulation results, specific device parameters and a setting position of the apparatus are selected.

5. The method for collecting inert particles in the kitchen waste slurry according to claim 1, characterized in that the Venturi-type collector for the inert particles in the kitchen waste slurry comprises an inlet pipeline interface, a variable-diameter Venturi pipe, the settling straight pipe, an observation flush pipe, a particle collection pipe, a filter mesh, a slurry flowing pipe, a reducing pipe, and an outlet pipeline interface.

6. The method for collecting inert particles in the kitchen waste slurry according to claim 5, characterized in that the inert particle collection apparatus uses the Venturi effect to separate the inert particles from a slurry main body; the inert particle collection apparatus takes the settling straight pipe as a main body; and according to the simulation results, an opening is formed in a settlement and accumulation position of the inert particles in the straight pipe, and an observation flush port is formed in an upper part of a corresponding position of the opening to facilitate observation of the settlement condition and flushing during collection of the inert particles.

7. The method for collecting inert particles in the kitchen waste slurry according to claim 5, characterized in that the variable-diameter Venturi pipe is connected with the inert particle collection apparatus, wherein the settling straight pipe is connected to the variable-diameter Venturi pipe; the observation flush pipe is connected to an upper end of the settling straight pipe, and the particle collection pipe is connected to a lower end; an outlet of the straight pipe is connected to the reducing pipe and the outlet pipeline interface; and the three portions together form an inert particle collection apparatus.

8. The method for collecting inert particles in the kitchen waste slurry according to claim 5, characterized in that the collector for the inert particles in the kitchen waste slurry comprises five portions: the settling straight pipe, the observation flush pipe, a connection pipe, the particle collection pipe, and the slurry flowing pipe; the observation flush pipe is used for observing deposition of the inert particles and flushing during collection to facilitate all the inert particles to enter the collection pipe; the particle collection pipe is provided with the filter mesh, and may be disassembled into two portions; and a liquid phase portion returns to a slurry pool by means of the filter mesh, and the inert particles are collected and transported outward.

9. The method for collecting inert particles in the kitchen waste slurry according to claim 1, characterized in that a replacement operation of the filter mesh is done manually; by splitting the slurry flowing pipe of the collector of the inert particles in the kitchen waste slurry, the particle collection pipe segment is directly taken out, together with the inert substances therein; and besides, a new collection filter mesh is replaced and reconnected with a slurry flowing pipeline, and a new round of waste collection process starts.

10. An apparatus for collecting inert particles in a kitchen waste slurry, characterized by comprising the Venturi-type collector for the inert particles in the kitchen waste slurry, wherein the Venturi-type collector for the inert particles in the kitchen waste slurry comprises the inlet pipeline interface, the variable-diameter Venturi pipe, the settling straight pipe, the observation flush pipe, the particle collection pipe, the slurry flowing pipe, the reducing pipe, and the outlet pipeline interface;
the inlet pipeline interface, the variable-diameter Venturi pipe, the settling straight pipe, the slurry flowing pipe, the reducing pipe, and the outlet pipeline interface are connected with each other sequentially; an inner diameter of the settling straight pipe is larger than the diameters of the inlet pipeline interface and the outlet pipeline interface; an inner diameter of the variable-diameter Venturi pipe is a portion with the smallest inner diameter in the Venturi-type collector for the inert particles in the kitchen waste slurry; and
the observation flush pipe is arranged on one side of the settling straight pipe, and the particle collection pipe is arranged on the other side, corresponding to the observation flush pipe, of the settling straight pipe.

11. The apparatus for collecting inert particles in the kitchen waste slurry according to claim 10, characterized in that the particle collection pipe is provided with a filter hole, and may be disassembled into three portions: the connection pipe, the particle storage pipe, and the slurry flowing pipe; the slurry passing through the filter mesh returns to the slurry pool, and the inert particles are collected and transported outward; and a connection pipe cover is arranged between the connection pipe and the particle collection pipe.

12. An application of the apparatus for collecting inert particles in the kitchen waste slurry according to claim 10, characterized in that the apparatus for collecting the inert particles in the kitchen waste slurry is used for modular treatment of collection or sustainable recycling of the inert particles in the kitchen waste slurry.

13. The application of the apparatus for collecting inert particles in the kitchen waste slurry according to claim 12, characterized in that the observation flush pipe is connected to an upper side of the settling straight pipe; an observation port with a diameter of 50 mm larger than that of the collecting pipe is arranged just above the collecting pipe, to facilitate observation on a settling state of the particles during cleaning of the inert particles; or process water is flushed from the upper side to help the inert particles all enter the collection pipe.

14. The application of the apparatus for collecting inert particles in the kitchen waste slurry according to claim 12, characterized in that in the inert particle collection pipe, a pipe cover is arranged at the connection pipe portion; during normal operation of the process, the pipe cover is closed; after reaching the settlement cycle, the pipe cover is manually opened, and connected with the particle collection pipe with the filter mesh; the flushed inert particles are intercepted by the filter mesh into the storage pipe; and the slurry and small particulate organic matters return to the pretreatment system after passing through the filter mesh.

15. The application of the apparatus for collecting inert particles in the kitchen waste slurry according to claim 12, characterized in that the application comprises the collection of inert particles in the kitchen waste slurry, comprising the following steps:
measuring the width of a slurry pipe, the range of flow velocity of the slurry and the density of inert particles after slurrying of the kitchen waste slurry to be processed;
obtaining a combination of parameters by using a two-phase flow simulation model, wherein the parameters comprise one or more of the following: a reducing ratio of the variable-diameter Venturi pipe, the length of a throat, the length of the settling straight pipe, the length of a diverging pipe, the length of the reducing pipe, and an aperture of the filter mesh; and
obtaining the parameter combination with the lowest concentration of a dispersed phase and the position of the Venturi-type collector for the inert particles in the kitchen waste slurry.

16. The application of the apparatus for collecting inert particles in the kitchen waste slurry according to claim 12, characterized by comprising the following steps:
connecting the Venturi-type collector for the inert particles in the kitchen waste slurry to a pipe segment of a kitchen waste pretreatment device, collecting the inert particles every day, and calculating the diameters and lengths of the particle collection pipe and the settling straight pipe, and a collection cycle by using a maximum value of each collection amount as a volume of a required reservoir.
